(19) United States
(12) Patent Application Publication
(10) Pub. No.: US 2026/0320313 A1
(43) Pub. Date: Oct. 15, 2026

(54) STORAGE MEDIUM, INFORMATION PROCESSING APPARATUS, METHOD OF CONTROLLING INFORMATION PROCESSING APPARATUS, AND INFORMATION PROCESSING SYSTEM

(71) Applicant: CANON KABUSHIKI KAISHA, Tokyo (JP)

(72) Inventor: TAKAYUKI KAWASHIMA, Kanagawa (JP)

(21) Appl. No.: 19/291,828

(22) Filed: Aug. 6, 2025

(30) Foreign Application Priority Data
Aug. 6, 2024 (JP) 2024-129940

(51) Int. Cl. G06F 40/58; G06F 40/166

(52) U.S. Cl. CPC G06F 40/58; G06F 40/166

(57) ABSTRACT

To appropriately convert design data, a storage medium storing a program for causing a computer to function as: a display control unit configured to display design data; and a reception unit configured to receive an input of setting information used in conversion of data included in the design data. The display control unit executes display control to display design data in which text data included in the design data has been translated based on the setting information and image data included in the design data has been converted into image data generated based on the setting information.

### BACKGROUND

### Field of the Technology

The present disclosure relates to a storage medium, an information processing apparatus, a method of controlling the information processing apparatus, and an information processing system.

### Description of the Related Art

There are systems to assist in creating designs for posters, flyers, etc. Some of these systems are equipped with a function of translating text in design data. In this case, the translation of text in design data is performed by obtaining the text from the design data and machine-translating the obtained text into a language specified by an operator Japanese Patent Laid-open Publication No. 2007-026398 discloses a technology to obtain and translate text in design data as well as to convert an original text element that is rendered as an image in the design data into a text element corresponding to the target language.

There is a demand for technologies to convert design data more appropriately.

### SUMMARY OF THE INVENTION

A storage medium according to the present disclosure causes a computer to function as: a display control unit configured to display design data; and a reception unit configured to receive an input of setting information used in conversion of data included in the design data. The display control unit executes display control to display design data in which text data included in the design data has been translated based on the setting information and image data included in the design data has been converted into image data generated based on the setting information.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating the entire configuration of a present system;

FIG. 2A is a hardware block diagram of an operator computer (PC);

FIG. 2B is a hardware block diagram of a service server;

FIG. 3 is a software block diagram of the present system;

FIG. 4 is a diagram illustrating an example of a data table of design data;

FIG. 5A is a diagram illustrating an example of processing by a multimodal large-scale language model;

FIG. 5B is a diagram illustrating another example of processing by the multimodal large-scale language model;

FIG. 6A is a diagram illustrating an example of processing by an image generation model;

FIG. 6B is a diagram illustrating another example of processing by the image generation model;

FIG. 7 is a diagram illustrating an example of a design data editing screen;

FIG. 8 is a sequence diagram illustrating the processing between the apparatuses;

FIG. 9A is a diagram illustrating an example of design conversion on the design data editing screen;

FIG. 9B is a diagram illustrating the example of design conversion on the design data editing screen;

FIG. 10 is a flowchart illustrating the details of processing on the operator PC;

FIG. 11 is a flowchart illustrating the details of processing on the service server;

FIG. 12A is a diagram illustrating an example of design conversion on the design data editing screen;

FIG. 12B is a diagram illustrating the example of design conversion on the design data editing screen;

FIG. 13 is a flowchart illustrating the details of processing on the service server;

FIG. 14A is a diagram illustrating an example of design conversion on the design data editing screen;

FIG. 14B is a diagram illustrating the example of design conversion on the design data editing screen;

FIG. 15 is a diagram showing the relationship of FIGS. 15A and 15B, and FIGS. 15A and 15B are flowcharts illustrating the details of processing on the service server;

FIG. 16 is a diagram showing the relationship of FIGS. 16A and 16B, and FIGS. 16A and 16B are flowcharts illustrating the details of processing on the service server;

FIG. 17 is a diagram showing the relationship of FIGS. 17A and 17B, and FIGS. 17A and 17B are flowcharts illustrating the details of processing on the service server; and

FIG. 18 is a diagram showing the relationship of FIGS. 18A and 18B, and FIGS. 18A and 18B are flowcharts illustrating the details of processing on the service server.

### DESCRIPTION OF THE EMBODIMENTS

Hereinafter, embodiments of the present disclosure are described with reference to the accompanying drawings. The following embodiments do not limit the present disclosure, and not all the combinations of features described in the embodiments are essential to the solution of the present disclosure. The same components are described with the same reference numerals. The steps in the flowcharts are denoted by reference numerals starting with “S”. In the following description, a text element rendered as an image in design data is referred to as an in-image text element or simply a text element. A non-text element rendered as an image in design data is referred to as an in-image non-text element or simply a non-text element.

### First Embodiment

### <<Entire Configuration of System>>

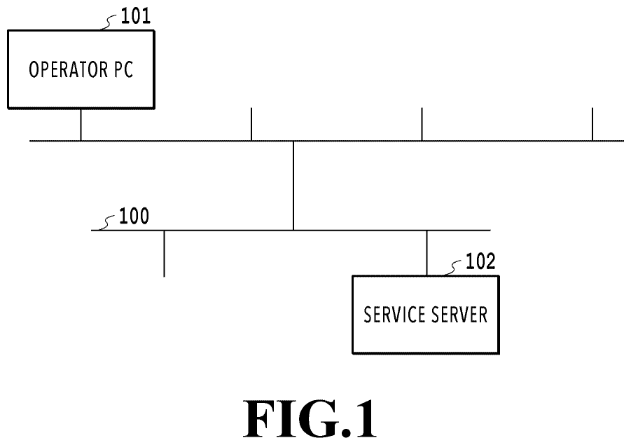

FIG. 1 is a diagram illustrating the entire configuration of an information processing system according to the present disclosure. The information processing system includes an operator computer (PC) 101 and a service server 102. The operator PC 101 and the service server 102 are communicably connected to each other via a network 100. For example, this network 100 is the internet, a wired local area network (LAN), or a wireless LAN. The operator PC 101 is a computer that executes an application to edit design data for a poster, a flyer, etc. The operator PC 101 transmits a request for certain editing, data processing, and rendering processes related to design data, to the service server 102 through the application. The service server 102 is a server that executes editing, data processing, and rendering processes for design data. The information processing system of the first embodiment has the configuration including the operator PC 101 and the service server 102 but is not limited thereto. For example, the operator PC 101 also serves as the service server 102. The operator PC 101 may include two or more operator PCs 101, and the service server 102 may include two or more service servers 102. The operator PC 101 and the service server 102 are information processing apparatuses and may be the PC described above, a tablet terminal, or any proper apparatus.

### <<Hardware Configuration of Operator PC>>

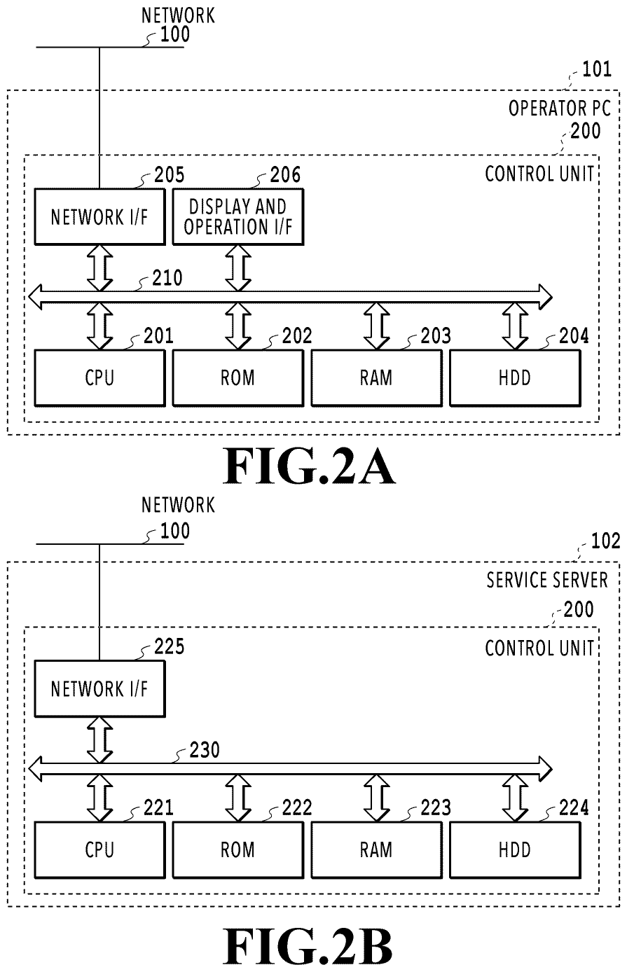

FIG. 2A is a hardware block diagram of the operator PC 101. In a control unit 200, a CPU 201, a ROM 202, a RAM 203, a hard disk drive (HDD) 204, a network I/F 205, and a display and operation I/F 206 are communicably connected to each other via a system bus 210. The control unit 200, which includes the CPU 201, controls the overall operation of the operator PC 101.

The CPU 201 reads various programs, including a control program, a system program, and an application program, stored in the storage devices (the ROM 202, RAM 203, and HDD 204), By executing the read various programs, the CPU 201 functions as units executing processes, such as print control, reading control, and image processing.

The storage devices store and retain various programs, image data, and the like. The storage devices include the ROM 202 as a non-volatile memory, the RAM 203 as a volatile memory, and the HDD 204 as a large-capacity storage area.

The ROM 202 is a non-volatile memory that retains various programs and the like, and the retained various programs are read and executed by the CPU 201. The RAM 203 is a volatile memory used as a main memory of the CPU 201 or a temporary storage area, such as a work area. The HDD 204 is a non-volatile memory used as a large-capacity storage area storing data, such as images processed by the CPU 201. The HDD 204 may be a solid-state drive (SSD), a flash memory, a cloud storage, and the like

The network I/F 205 connects the control unit 200 of the operator PC 101 to the network 100. The network I/F 205 transmits image data and information to an external apparatus on the network 100 and receives various information from an external apparatus on the network 100. The display and operation I/F 206 connects the control unit 200 to an output apparatus, such as a display apparatus, and an input apparatus, such as a keyboard and a mouse, via a system bus 210. The first embodiment is described with a display apparatus, a keyboard, and a mouse, for example, but the output and input apparatuses are not limited thereto. The output and input apparatuses may be integrated using a touch panel.

### <<Hardware Configuration of Service Serve>>

FIG. 2B is a hardware block diagram of the service server 102. In a control unit 220, a CPU 221, a ROM 222, a RAM 223, an HDD 224, and a network I/F 225 are communicably connected to each other via a system bus 230.

The control unit 220, which includes the CPU 221, controls the overall operation of the service server 102. The CPU 221 reads various programs, including a control program, a system program, and an application program, stored in the storage devices (the ROM 222, RAM 223, and HDD 224) and executes the read various processes. The ROM 222 is a non-volatile memory that retains various programs and the like, and the retained various programs are read and executed by the CPU 221. The RAM 223 is used as a main memory of the CPU 221 or a temporary storage area, such as a work area. The HDD 224 stores document data and various programs. The HDD 224 may be an SSD, a flash memory, a cloud storage, and the like. The network I/F 225 connects the control unit 220 of the service server 102 to the network 100. The service server 102 transmits and receives various information upon receiving a processing request through the application from another apparatus, such as the operator PC 101, via the network I/F 225.

### <<Software Configuration of System>>

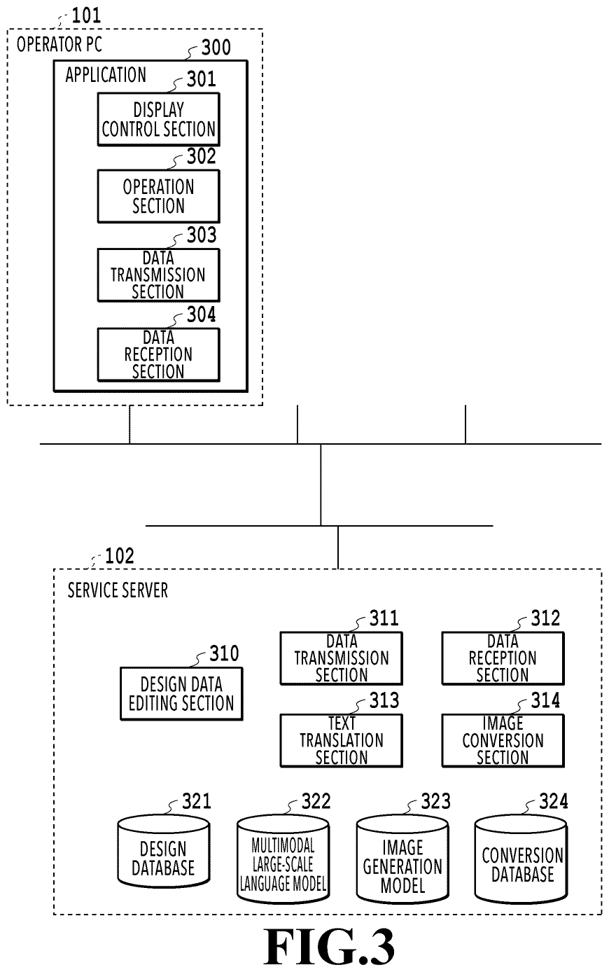

FIG. 3 is a software block diagram of the information processing system. The software configurations of the operator PC 101 and the service server 102 are described. The operator PC 101 includes an application 300. The application 300 is a program module that executes edits on design data for a poster, a flyer, etc. The program of the application 300 is stored in a storage device (the ROM 202 or the HDD 204). The program of the application 300 is executed by the CPU 201 loading the program of the application 300 into the RAM 203. The application 300 includes a display control section 301, an operation section 302, a data transmission section 303, and a data reception section 304. The display control section 301 displays an application screen on the display apparatus via the display and operation I/F 206. The operation section 302 receives a user input from the mouse and keyboard via the display and operation I/F 206. The data transmission section 303 transmits an instruction to process design data to the service server 102 via the network I/F 205 in response to an instruction from the operation section 302. The data reception section 304 receives the result of processing design data from the service server 102 via the network I/F 205.

The service server 102 includes a design data editing section 310, a data transmission section 311, a data reception section 312, a text translation section 313, and an image conversion section 314. The service server 102 also includes a design database 321, a multimodal large-scale language model 322, an image generation model 323, and a conversion database 324. The design data editing section 310 edits the design data for a poster, a flyer, or the like based on a processing instruction from the application 300 of the operator PC 101. For example, the design data editing section 310 adds and deletes objects, including text, images, and shapes, in the design data and adjusts the coordinates, size, and color of each object. The design data is stored in the design database 321 for each application 300 of the operator PC 101 (or in a case where there are plural user accounts, for each account).

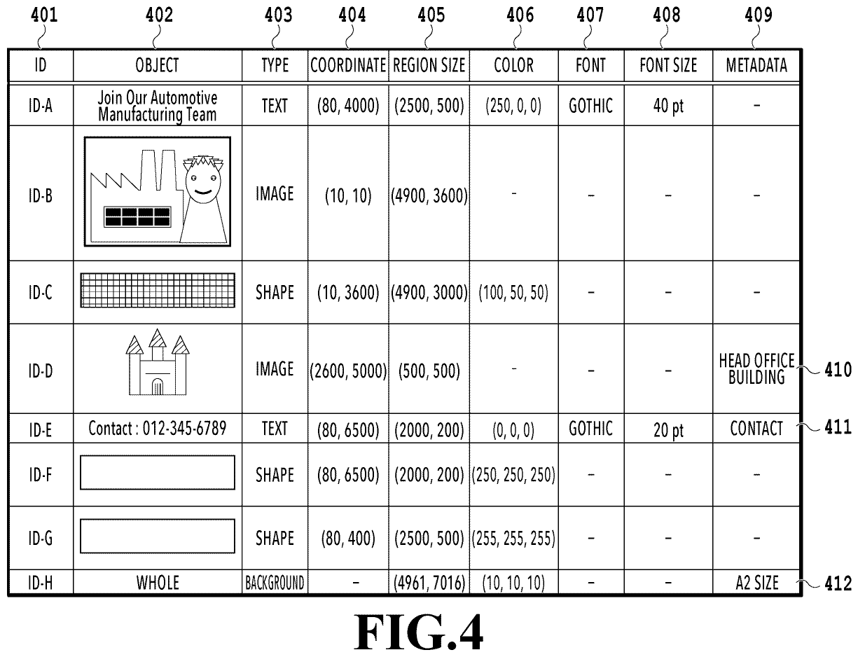

FIG. 4 illustrates an example of a data table of design data that is stored in the design database 321 and managed by the service server 102. The data table includes parameters, such as an ID 401 for uniquely identifying an object in the design data, an object 402, an object type 403, a coordinate 404, an area size 405, a color 406, a font 407, a font size 408, and metadata 409. The object 402 stores values of various objects, such as text, images, and shapes in the design data. The object type 403 stores information representing the type of each object. The coordinate 404 stores values representing the positions of each object in the design data. The area size 405 stores values representing the size of each object. In the first embodiment, in a case where the object type is text. the coordinate 404 and the area size 405 indicate the coordinates and size of a text area prepared for the text. The color 406 stores values representing the color of each object in terms of RGB values. The color 406 does not need to have a setting value for image objects. The color 406 may store HSV values, instead of RGB values. The font 407 stores values representing the font type of each text object. The font size 408 stores values representing the font size of each text object. The metadata 409 stores metadata for each object. In the first embodiment, in a case where the object type is image or text, the metadata can be a description or attribute of the image or text object. For example, the metadata can be a description of an image like an item 410 and an attribute of text like an item 411. In a case where the object type is background, the metadata may be a description of the document size of the background. For example, the metadata may be a description “A2 size” like an item 412. The metadata does not need to be set for all objects. The data table illustrated in FIG. 4 is provided for each set of design data. The data table may be created for each object type. Furthermore, the data table may include parameters in addition to those described above.

The data transmission section 311 transmits the result of processing the design data to the application 300 of the operator PC 101 via the network I/F 225. The data reception section 312 receives an instruction to process the design data from the application 300 of the operator PC 101 via the network I/F 225. The text translation section 313 machine-translates a text object in the design data into a specified language. The conversion database 324 retains setting information for design conversion. The setting information for design conversion is setting information including languages available for translation, locales representing countries and regions, and information that associates the locales with the languages available for translation. The image conversion section 314 converts an image object in the design data using the multimodal large-scale language model 322 and the image generation model 323. In the first embodiment, the multimodal large-scale language model 322 and the image generation model 323 are disposed in the service server 102. However, the present disclosure is not limited thereto. In a case where the service server 102 can use a multimodal large-scale language model and an image generation model that are managed by an external apparatus, such as a server, the service server 102 may convert the design data using these models. The service server 102 may therefore include a conversion control section (not illustrated) to control the text translation section 313 and the image conversion section 314.

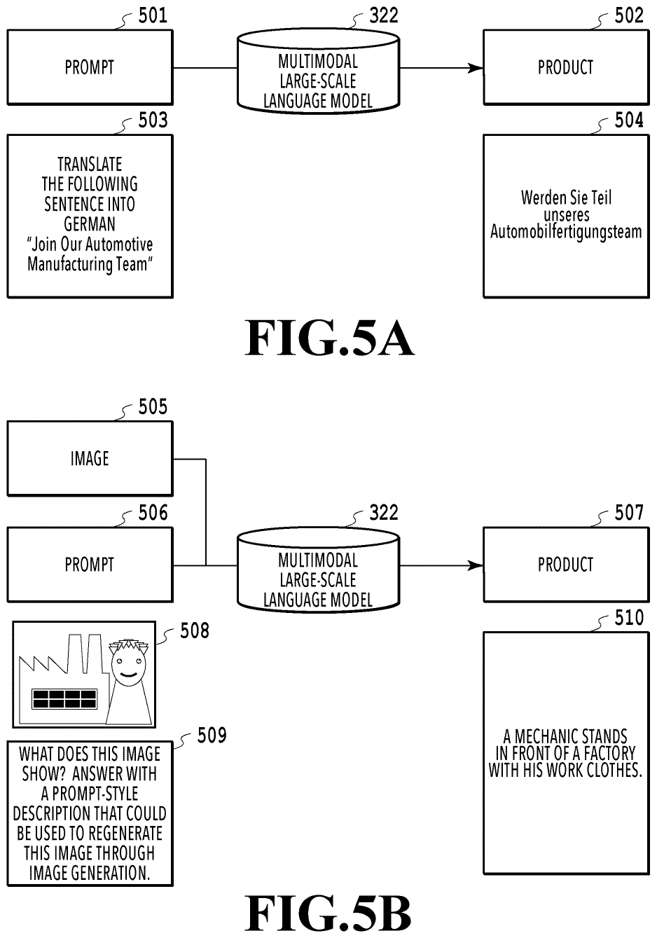

FIGS. 5A and 5B are diagrams illustrating examples of processing by the multimodal large-scale language model 322. Before describing the multimodal large-scale language model, a large-scale language model is described. The large-scale language model is a language model that is composed of plural neural network layers and is trained on a large amount of text. The parameters of each neural network layer are adjusted by training on a task of predicting the most likely word to come next to a given word. This enables the large-scale language model to generate text that is highly likely to match the inputted text. Specifically, the large-scale language model divides the inputted text into tokens, which are the basic units of processing, and converts each token to an embedding expression that numerically represents the meaning of a word or a sentence. The conversion to the embedding expressions enables numerical representation of the context of the inputted text. Based on these obtained embedding expressions, the large-scale language model generates text that is highly likely to match these embedding expressions.

The multimodal large-scale language model is a large-scale language model capable of processing plural types of information, such as images, audio, and video as well as text. A multimodal large-scale language model that receives images calculates image feature amounts from an inputted image using an image encoder. By mapping the calculated image feature amounts to the embedding expressions of the large-scale language model, the large-scale language model is enabled to process inputs of image information. The multimodal large-scale language model can thereby generate text that is highly likely to match the inputted text or image. The multimodal large-scale language model also can output the embedding expressions of the inputted text or images. Furthermore, by varying the inputted text or images, the multimodal large-scale model can perform processing for various tasks that were not present in the training data. Specifically, the multimodal large-scale language model can translate text as illustrated in FIG. 5A and describe an image as illustrated in FIG. 5B. As illustrated in FIG. 5A, when receiving a prompt 501, which represents an instruction regarding a product, the multimodal large-scale language model 322 outputs a text product 502, which is highly likely to match the prompt 501. In the example in FIG. 5A, when an input prompt 503 is inputted to the multimodal large-scale language model 322, an output product 504 is outputted. As illustrated in FIG. 5B, when receiving an image 505 and a prompt 506, the multimodal large-scale language model 322 can output a text product 507, which is highly likely to match the image 505 and the prompt 506. In the example in FIG. 5B, when an input image 508 and an input prompt 509 are inputted to the multimodal large-scale language model 322, an output product 510 is outputted. Specific examples of the multimodal large-scale language model 322 include ChatGPT (https://chat.openai.com) and Gemini (https://gemini.google.com). The first embodiment can use any multimodal large-scale language model.

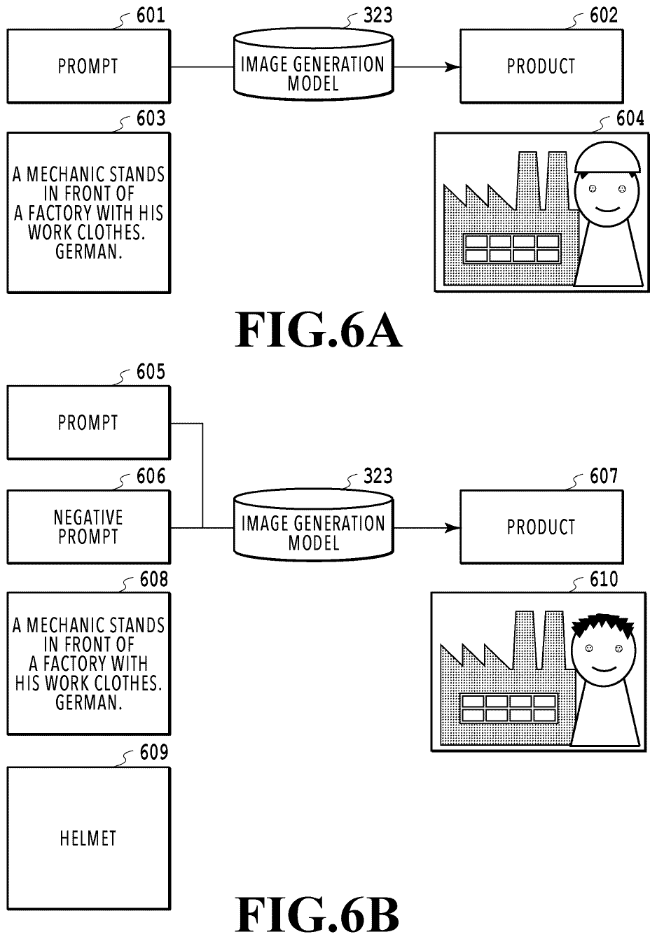

FIGS. 6A and 6B are diagrams illustrating examples of processing by the image generation model 323. The image generation model is a model that is composed of plural neural networks and is trained on a large amount of text and images. The parameters of each neural network layer are adjusted by training on a task of generating from inputted text, an image corresponding to the inputted text. This enables the image generation model to generate an image that is highly likely to match the inputted text. Specifically, the image generation model divides the inputted text into tokens, which are the basic units of processing, and converts each token to the embedding expression that numerically represents the meaning of a word or a sentence. The conversion to the embedding expressions enables numerical representation of the context of the inputted text. Based on the obtained embedding expressions, the image generation model generates an image that is highly likely to match these embedding expressions. Furthermore, inputting the embedding expressions to the image generation model can yield an image that is highly likely to match the embedding expressions.

As illustrated in FIG. 6A, when receiving a prompt 601, the image generation model 323 outputs an output image product 602, which is highly likely to match the prompt 601. In the example in FIG. 6A, when an input prompt 603 is inputted to the image generation model 323, an output product 604 is outputted. As illustrated in FIG. 6B, when receiving a prompt 605 and a negative prompt 606, the image generation model 323 can also generate an output image product 607, which is highly likely to match the prompt 605 and the negative prompt 606. Here, the negative prompt refers to an instruction regarding an element that is not desired to be included in the generated image. In the example in FIG. 6B, when an input prompt 608 and an input negative prompt 609 are inputted to the image generation model 323, an output product 610 is outputted. The negative prompt 606 may be inputted to the image generation model 323 separately from the prompt 605 as illustrated in FIG. 6B or may be combined with the prompt 605 to be inputted to the image generation model 323 as a single prompt. In a case where the negative prompt 606 is combined with the prompt 605, the instruction by the negative prompt 606 should be phrased in the negative form, such as “do not include a helmet”. Examples of the image generation model 323 include StableDiffusion (https://ja.stability.ai/stable-diffusion) and Midjourney (https://www.midjourney.com). The first embodiment can use any image generation model.

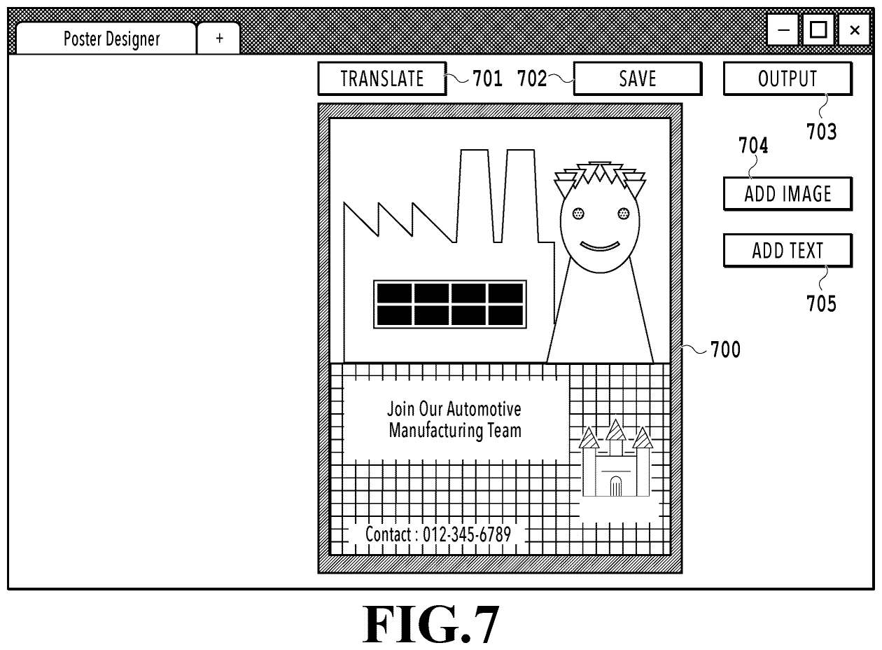

FIG. 7 is a diagram illustrating an example of a design data editing screen. The design data editing screen is displayed by the display control section 301 on the display apparatus of the operator PC 101 via the application 300. The design data editing screen includes a design edit area 700, a translate button 701, a save button 702, an output button 703, an add image button 704, and an add text button 705. In the design edit area 700, the design data currently being edited is displayed. For each object displayed in the design edit area 700, the design data editing section 310 executes edits on the object itself, such as adjustment of its position and size, based on a user input received by the operation section 302. In order to add an image or text object to the design edit area 700, the add image button 704 or the add text button 705 is pressed. Upon the add image button 704 being pressed, the design data editing section 310 calls a file dialog to specify a file path and performs an import process. Of course, it is acceptable to dispose an additional button corresponding to another object type, and the import source may be an external cloud service or a social networking service (SNS). In addition, the design data editing section 310 may receive a content addition to the design edit area 700 via drag and drop. To convert the design data, the translate button 701 is pressed. To save the design data currently being edited, the save button 702 is pressed to store the design data in the design database 321, Pressing the output button 703 can output the design data currently being edited in PDF or JPEG format.

In the description of the configuration example in FIG. 3, the service server 102 includes the design data editing section 310, the text translation section 313, and the image conversion section 314. However, the first embodiment is not limited to this configuration. The application 300 of the operator PC 101 may include the functions as the design data editing section 310, the text translation section 313, and the image conversion section 314.

### <<Processing Sequence>>

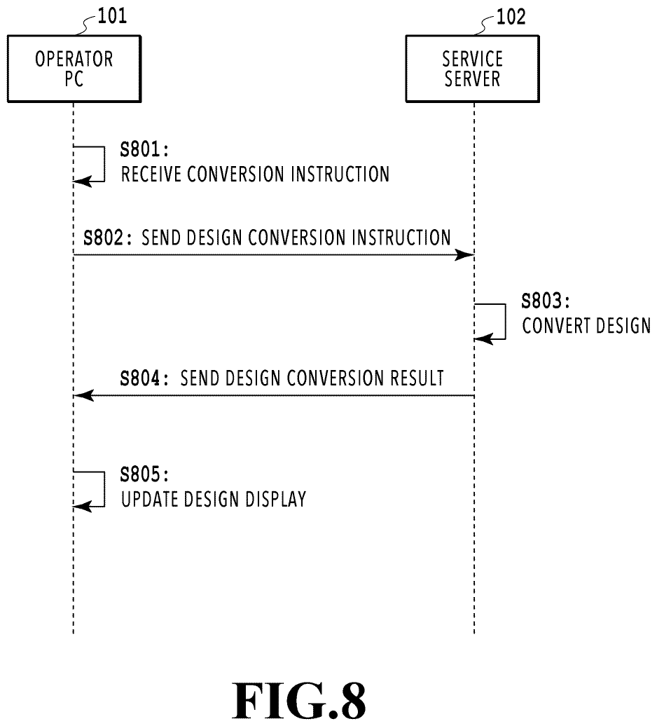

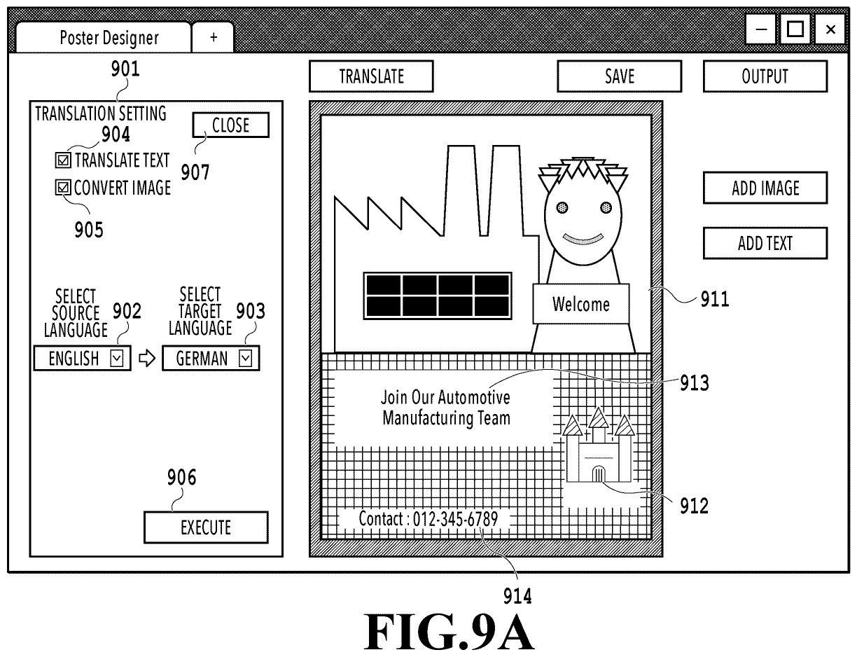

The processing sequence of the information processing system in the first embodiment is described with reference to FIG. 8. The following describes the processing on each apparatus in a case where design conversion instruction information received through the application 300 of the operator PC 101 is sent to the service server 102 and the design display is updated based on a design conversion result. The design data currently being edited in the operator PC 101 is data stored in the design database 321 of the service server 102 and managed by the service server 102. Although in the first embodiment, the design data is stored in the design database 321 of the service server 102, the present disclosure is not limited thereto. The design data may be stored in an external storage device or a cloud storage managed by the service server 102, for example. The design conversion instruction information is managed by the operator PC 101.

In S801, the operation section 302 of the application 300 receives a design conversion instruction from the user via the display and operation I/F 206. The design conversion instruction includes setting values, such as instructions on whether to translate text and whether to convert images and specifications of the source language for translation, the target language for translation, and the locale representing a country or region. Furthermore, the design conversion instruction may include position information of the operator PC 101.

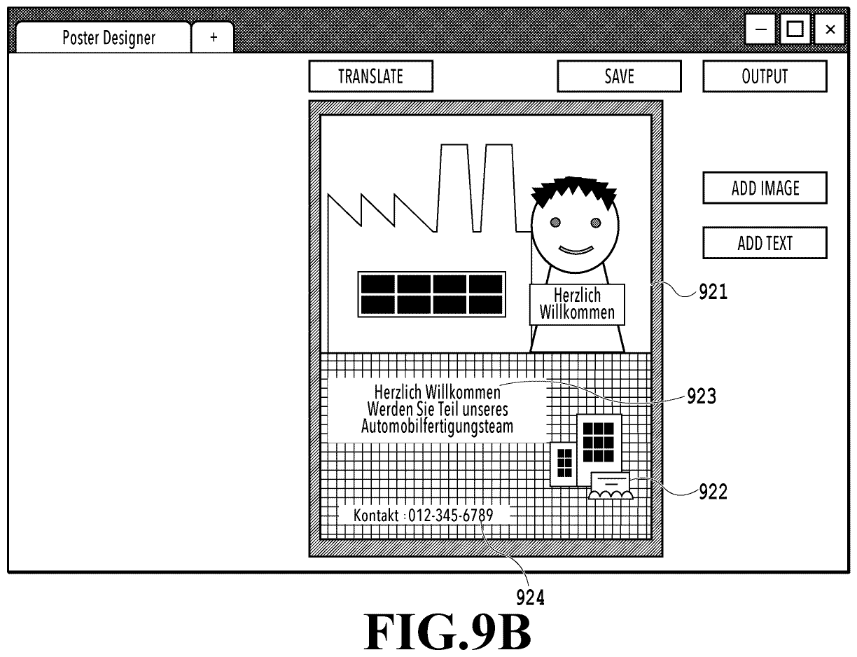

FIGS. 9A and 9B illustrate an example of design conversion on the design data editing screen of the first embodiment. FIG. 9A illustrates an example of screen display when the translate button 701 is pressed in FIG. 7. In FIG. 9A, a translation setting field 901 is disposed. The translation setting field 901 includes a setting item 904, which specifies whether to translate the language of text objects in the design data, and a setting item 905, which specifies whether to convert image objects in the design data. The translation setting field 901 also includes a setting item 902, which includes the source language for translation, and a setting item 903, which includes the target language for translation. When an execute button 906 is pressed, the design conversion instruction is received based on the setting values set in the respective setting items. When a close button 907 is pressed, the translation setting field 901 is closed. FIG. 9A depicts the state where the instruction to translate text has been specified, the instruction to convert images has been specified, the source language for translation is set to “English”, and the target language for translation is set to “German”.

In S802, when the aforementioned execute button 906 is pressed and the design conversion instruction is received, the data transmission section 303 of the application 300 transmit the design conversion instruction information to the service server 102. The design conversion instruction information includes the setting values, such as the instructions on whether to translate text and whether to convert images and the specifications of the source language for translation, the target language for translation, and the locale representing a country or region. The design conversion instruction information may include the position information of the operator PC 101.

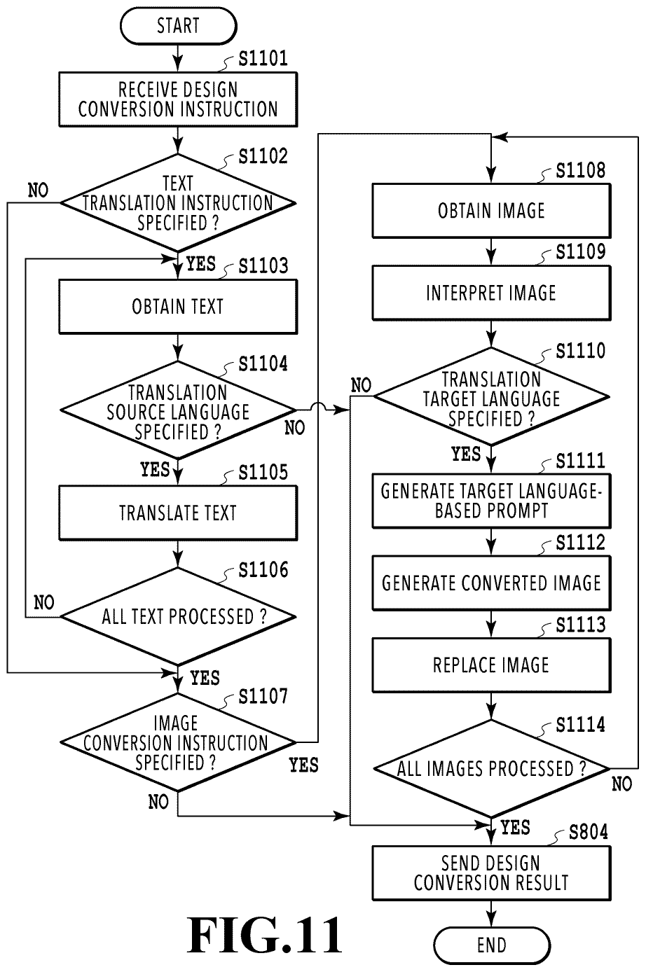

In S803, the service server 102 converts the design data based on the setting values, such as the target language for translation and the locale. The details of the design conversion process are described later in FIG. 11. In S804, the data transmission section 311 of the service server 102 transmits the design conversion result to the application 300 of the operator PC 101. In S805, the display control section 301 of the application 300 updates the design data currently being edited on the design editing screen to the display of the design conversion result. Through the above processing sequence, the design conversion instruction information received by the application 300 of the operator PC 101 can be sent to the service server 102, and the design display can be updated based on the design conversion result (converted design data) (see FIG. 9B).

### <<Processing Flow of Operator PC 101>>

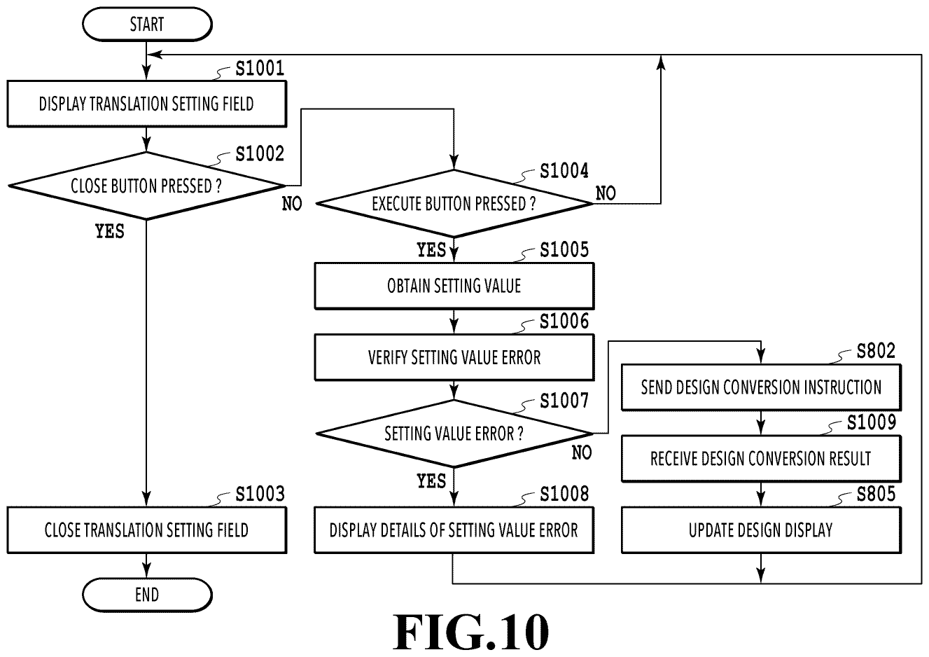

FIG. 10 is a flowchart illustrating a conversion instruction receiving process and a design display updating process executed by the application 300 of the operator PC 101 in the first embodiment. The flowchart includes S802 and S805 illustrated in FIG. 8. S801 in FIG. 8 corresponds to S1001, S1002, S1003, S1004, S1005, S1006, S1007, and S1008 of this flowchart. The processing in this flowchart is implemented by, for example, the CPU 201 loading an application program stored in the ROM 202 into the RAM 203 and executing the same. The processing in this flowchart starts upon the translate button 701 being pressed on the design data editing screen.

In S1001, the display control section 301 displays the translation setting field on the design data editing screen. In S1002, the operation section 302 determines whether the close button in the translation setting field has been pressed. In a case where it is determined that the close button in the translation settings field has been pressed, the processing proceeds to S1003. In a case where it is determined that the close button in the translation setting field has not been pressed, the processing proceeds to S1004. In S1003, the display control section 301 closes the translation setting field on the design data editing screen, and the processing in the flowchart ends.

In S1004, the operation section 302 determines whether the execute button in the translation setting field has been pressed. In a case where it is determined that the execute button in the translation setting field has been pressed, the processing proceeds to S1005. In a case where it is determined that the execute button in the translation setting field has not been pressed, the processing returns to S1001. In S1005, the operation section 302 obtains the setting values regarding the design conversion instruction. The processing then proceeds to step S1006. The setting values include the instructions on whether to translate text and whether to convert images and the specifications of the source language for translation, the target language for translation, and the locale representing a country or region. For example, FIG. 9A depicts the state where the instruction to translate text has been specified, the instruction to convert images has been specified, the source language for translation is set to “English”, and the target language for translation is set to “German”.

In S1006, the operation section 302 verifies whether the setting values include any error. The processing then proceeds to S1007. Specifically, the operation section 302 determines that there is a setting value error in a case where the instruction to translate text has not been specified and the instruction to convert images has not been specified. The operation section 302 also determines that there is a setting value error in a case where the source or target language for translation is “unselected”. In S1007, the operation section 302 determines whether there is a setting value error. In a case where there is a setting value error, the processing proceeds to S1008. In a case where there is no setting value error, the processing proceeds to S802. In S1008, the display control section 301 displays the details of the setting value error in the translation setting field. The processing then returns to S1001. In a case where the target language for translation is “unselected”, for example, the display control section 301 displays a dialogue box including an error message, such as “the target language for translation is not selected”.

In S802, the data transmission section 303 transmits the design conversion instruction information to the service server 102. The processing then proceeds to S1009. The design conversion instruction information includes the setting values, such as the instructions on whether to translate text and whether to convert images and the specifications of the source language for translation, the target language for translation, and the locale representing a country or region. The design conversion instruction information may further include the position information of the operator PC 101. In S1009, the data reception section 304 receives the design trans conversion formation result (converted design data) from the service server 1002, and the processing proceeds to S805. The processing in S1009 corresponds to receiving the design conversion result sent by the data transmission section 311 in S804.

In S805, the display control section 301 updates the design data currently being edited on the design editing screen to the display of the design conversion result. The processing then returns to S1001. Specifically, the display control section 301 replaces the design data currently being edited with the design conversion result to update the design editing screen. The design data currently being edited may be retained, and the design conversion result may be added as a new page, so that both the design data currently being edited and the design conversion result may be simultaneously displayed on the design editing screen. Alternatively, the design conversion result may be directly printed through a printer without being displayed on the display apparatus.

### <<Processing Flow of Service Server 102>>

FIG. 11 is a flowchart illustrating a design conversion process executed by the service server 102 in the first embodiment. The flowchart includes S804 illustrated in FIG. 8. S803 in FIG. 8 corresponds to S1102, S1103, S1104, S1105, S1106, S1107, S1108, S1109, S1110, S1111, S1112, S1113, and S1114 of this flowchart. The processing in this flowchart is implemented by, for example, the CPU 221 loading a program stored in the ROM 222 into the RAM 223 and executing the same. The processing in this flowchart starts upon the data reception section 312 of the service server 102 receiving the design conversion instruction information from the application 300 of the operator PC 101.

In S1101, the data reception section 312 receives the design conversion instruction information from the application 300 of the operator PC 101. The processing then proceeds to S1102. S1101 corresponds to receiving the design conversion instruction information sent by the data transmission section 303 in S802. In S1102, the text translation section 313 determines whether the instruction to translate text has been specified in the design conversion information. In a case where it is determined that the instruction to translate text has been specified, the processing proceeds to S1103. In a case where it is determined that the instruction to translate text has not been specified, the processing proceeds to S1107.

In S1103, the text translation section 313 obtains a text object from the design data. The processing then proceeds to S1104. In S1104, the text translation section 313 determines whether the target language for translation has been specified in the design conversion instruction information. In a case where it is determined that the target language for translation has been specified, the processing proceeds to S1105. In a case where it is determined that the target language for translation has not been specified, the processing proceeds to S804.

In S1105, the text translation section 313 translates the text of the obtained text object, and the processing proceeds to S1106. The text translation is performed using the multimodal large-scale language model 322. The text translation section 313 generates a prompt to cause the multimodal large-scale language model 322 to execute translation. In a case where the text translation section 313 obtains a text object 913 in FIG. 9A, for example, the text translation section 313 generates the following prompt.

“Translate the following sentence”.

“Join Our Automotive Manufacturing Team”

By inputting the above prompt to the multimodal large-scale language model 322, the following translation result text is obtained.

“Join Our Automotive Manufacturing Team (translated in German)”.

The text translation section 313 replaces the text of the obtained text object with the translated text outputted from the multimodal large-scale language model 322. At this process, in a case where the number of characters in the translated text is greater than that in the source text, the translated text may extend beyond the area of the text object. Therefore, another process may be added to reduce the font size of the text object in proportion to the increase in the number of characters. The method of translating text is not limited to the above method. For example, the text translation section 313 may hold a machine translation model trained on a large number of source text and translated text pairs and performs translation using this machine translation model. Then, the source text and translated text pairs are registered in the conversion database 324 in advance. In a case where the text of the obtained text object is registered as the source text, translation may be executed by replacing the text of the text object with the paired translated text.

In S1106, the text translation section 313 determines whether all the text objects in the design data have been processed. In a case where it is determined that all the text objects have been processed, the processing proceeds to S1107. In a case where it is determined that some of the text objects are unprocessed, the processing returns to S1103. In S1107, the image conversion section 314 determines whether the instruction to convert images has been specified in the design conversion instruction information. In a case where it is determined that the instruction to convert images has been specified, the processing proceeds to S1108. In a case where it is determined that the instruction to convert images has not been specified, the processing proceeds to S804.

In S1108, the image conversion section 314 obtains an image object in the design data. The processing then proceeds to S1109. In S1109, the image conversion section 314 interprets the image of the obtained image object, and the processing proceeds to S1110. Specifically, the image conversion section 314 represents the content of the image (e.g., what is depicted in the image) in text form. The image interpretation is performed using the multimodal large-scale language model 322. The image conversion section 314 generates a prompt to cause the multimodal large-scale language model 322 to interpret the image. In a case where the image conversion section 314 obtains an image object 911 in FIG. 9A, for example, the image conversion section 314 generates the following prompts.

“What does this image show?”

“Answer with a prompt-style description that could be used to regenerate this image through image generation.”

“If your answer includes any character string read from the image, enclose it in quotation marks.”

By inputting the above prompts and the image of the image object 911 into the multimodal large-scale language model 322, the following interpretation result text is obtained.

“A mechanic stands in front of a factory with his work clothes. The mechanic is holding a board in which “Welcome” is written.

Using the multimodal large-scale language model 322, image interpretation is performed for in-image text elements and in-image non-text elements. The non-text elements include images, illustrations, and shapes. In the above example, “Welcome”, enclosed in quotation marks, represents the in-image text element. The image interpretation method is not limited to the above method. For example, the image conversion section 314 may hold a generic object recognition model trained on categories of objects depicted in images and use the generic object recognition model to perform image interpretation for the in-image non-text element. As for the in-image text element, the image conversion section 314 may apply optical character recognition (OCR) to an image to extract text and its position and size. In a case where text is extracted by applying OCR, the image conversion section 314 may add a new text object including the extracted text as a value, to the front of the image object. In a case where text is extracted by applying OCR and the target language for translation has been specified, the text translation section 313 translates the text of the text object added by the image conversion section 314 into the specified target language for translation.

In S1110, the image conversion section 314 determines whether the target language for translation has been specified in the design conversion instruction information. In a case where it is determined that the target language for translation has been specified, the processing proceeds to S1111. In a case where it is determined that the target language for translation has not been specified, the processing proceeds to S804. In S1111, the image conversion section 314 generates a target language-based prompt as image generation instruction data using the target language for translation and the image interpretation result. The processing then proceeds to S1112. Specifically, the image conversion section 314 generates a prompt to generate a new image appropriate for the cultural area of the text language while retaining the content of the image of the obtained image object. In a case where the image interpretation result includes a text element and the target language for translation has been specified, the text translation section 313 translates the text element into the target language for translation. The image conversion section 314 then generates the target language-based prompt. In a case where the image conversion section 314 obtains the image object 911 in FIG. 9A and the target language for translation is “German”, the image conversion section 314 generates the following prompt.

“A mechanic stands in front of a factory with his work clothes. The mechanic is holding a board in which “Welcome” is written. Create an image appropriate for the German cultural area.”

In S1112, the image conversion section 314 generates a converted image using the target language-based prompt generated in S1111. The processing then proceeds to S1113. The converted image is generated using the image generation model 323. The image conversion section 314 inputs the target language-based prompt generated in S1111 to the image generation model 323. In a case where the image conversion section 314 obtains the image object 911 in FIG. 9A, for example, the image conversion section 314 inputs the following prompt.

“A mechanic stands in front of a factory with his work clothes. The mechanic is holding a board in which “Welcome” is written. Create an image appropriate for the German cultural area.”

By inputting the above prompt to the image generation modes 323, a converted image represented by an image object 921 in FIG. 9B is generated.

In S1113, the image conversion section 314 replaces the image of the obtained image object with the converted image generated in S1112. The processing then proceeds to S1114. In a case where the image size of the converted image is different from that of the obtained image object, the converted image is resized to the same size as the image of the obtained image object before the replacement process. In S1114, the image conversion section 314 determines whether all the image objects in the design data have been processed. In a case where it is determined that all the image objects have been processed, the processing proceeds to S804. In a case where it is determined that some of the image objects are unprocessed, the processing returns to S1108. In S804, the data transmission section 311 transmits the design conversion result to the application 300 of the operator PC 101. In a case where the transmission of the design conversion result is complete, the processing in the flowchart ends.

In the example of FIGS. 9A and 9B, the images of the image object 911 in FIG. 9A and the image object 912 are changed to the converted images represented by the image object 921 and an image object 922 in FIG. 9B, respectively. In this process, the text elements and non-text elements (the person, the building, etc.) in the images are changed to images appropriate for the German cultural area. The text objects 913 and 914 in FIG. 9A are translated into German, and translated text objects 923 and 924 are newly disposed as illustrated in FIG. 9B.

According to the first embodiment, an image in the design data is interpreted, and the target language-based prompt based on the interpretation result is generated. The image in the design data is replaced with a converted image generated based on the target language-based prompt. This enables appropriate conversion of the design data.

### Modification of First Embodiment

In the first embodiment, the target language-based prompt is generated in order to change an image in the design data to an image tailored to the cultural area of the text language. On the other hand, the step of generating the target language-based prompt in S1111 in the first embodiment may be replaced with another step to generate the image generation instruction data. For example, the step of generating the target language-based prompt may be replaced with a step of generating an impression-based prompt or a step of generating an age-based prompt. The setting values of the design conversion instruction may include a setting that specifies an impression or target age group. This allows an image in the design data to be easily changed into an image tailored to the target attribute, such as an impression or age group intended by the operator. For example, in order to change an original image in the design data to an image tailored to a “cool” impression, the impression-based prompt is generated as follows.

“A mechanic stands in front of a factory with his work clothes. The mechanic is holding a board in which “Welcome” is written. Create an image that gives a cool impression.”

In order to change an original image in the design data to an image tailored to “teenagers”, the age-based prompt is generated as follows.

“A mechanic stands in front of a factory with his work clothes. The mechanic is holding a board in which “Welcome” is written. Create an image suitable for teenagers.”

Furthermore, the step of generating the target language-based prompt may be replaced with a step of generating the target language-based embedding expression. Specifically, in S1109, the image conversion section 314 receives the image interpretation result from the multimodal large-scale language model 322, not as text but as the embedding expression. The image conversion section 314 then inputs text of “German cultural area” to the multimodal large-scale language model 322 and receives the embedding expression. The image conversion section 314 performs addition operation for the embedding expression of the image interpretation result and the embedding expression indicating “German cultural area” to generate the target language-based embedding expression. In S1112, the image conversion section 314 inputs the target language for the translation-based embedding expression to the image generation model 323 to generate a converted image. This allows an original image in the design data to be changed to an image tailored to the cultural area of the text language by using the embedding expressions without prompts.

### Second Embodiment

In the first embodiment, non-text elements, such as an image, in the design data are interpreted, and the target language-based prompt based on the interpretation result is generated. Then the non-text elements, such as an image, in the design data are replaced with non-text elements converted based on the target language-based prompt. This allows the operator to easily change the non-text elements, such as an image, in the design data into non-text elements tailored to the cultural area of the text language. However, all the non-text elements in the design data are converted, and even the non-text elements, such as an image, that the operator does not want to change, are replaced, which reduces the convenience. Therefore, the second embodiment describes an example where only selected non-text elements in the design data are converted into non-text elements tailored to the cultural area of the text language. The following describes only the differences from the first embodiment. The design data is assumed to include more than one non-text element.

### <<Processing Sequence>>

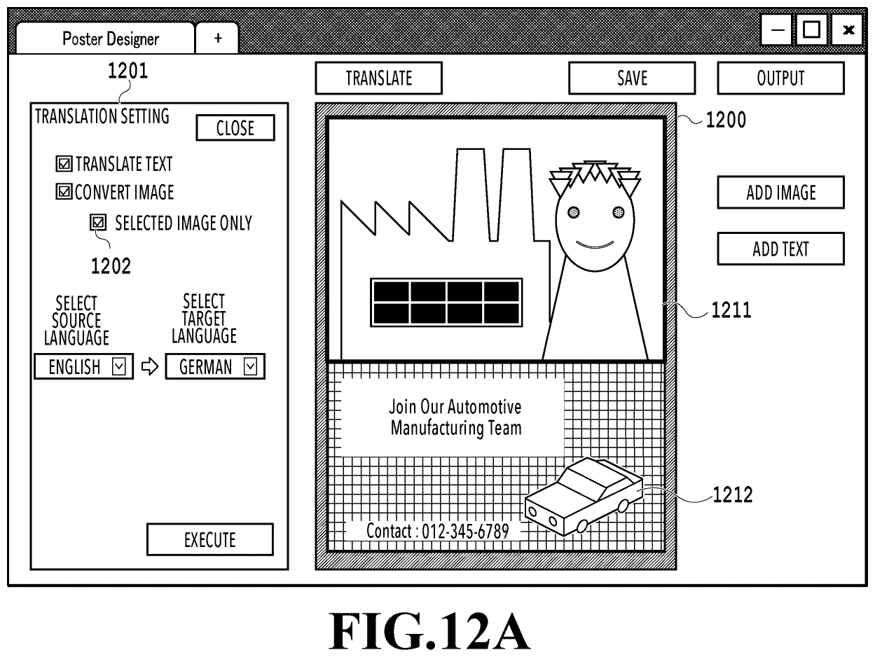

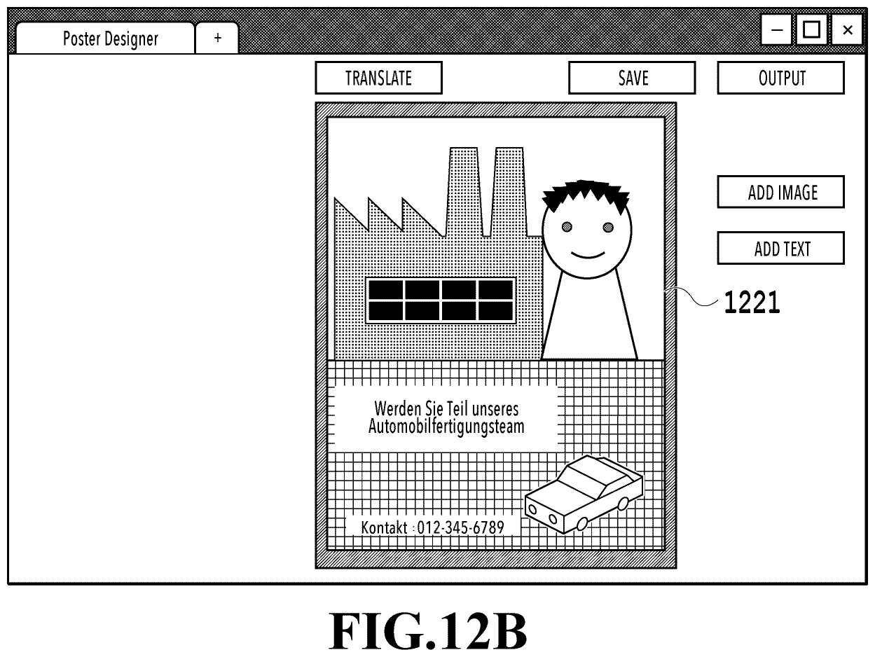

In S801 in FIG. 8, the operation section 302 of the application 300 receives the design conversion instruction from the user through the display and operation I/F 206. In the second embodiment, the design conversion instruction information includes a setting value that indicates whether each object is a conversion target element to be subjected to image conversion. FIGS. 12A and 12B illustrate an example of design conversion on the design data editing screen of the second embodiment. FIG. 12A illustrates the screen in which a translation setting filed 1201 is displayed. The translation setting field 1201 includes a setting item 1202, which includes an instruction on whether to convert only the conversion target elements in the process of converting image objects in the design data. In a case where the setting is made to convert only the conversion target elements, the operation section 302 of the application 300 receives a selection of one or more conversion target elements from the image objects in the design editing area 1200. FIG. 12A depicts the state in which the instruction to translate text has been specified, the instruction to convert images has been specified, the instruction to convert only the conversion target elements has been specified, the source language for translation is “English”, and the target language for translation is “German”. FIG. 12A also depicts the state in which an image object 1211 has been specified as the conversion target element whereas an image object 1212 has not been specified as the conversion target element.

### <<Processing Flow of Operator PC 101>>

In S1005 in FIG. 10, the operation section 302 obtains the setting values in the design conversion instruction. The setting values include an indication whether each object is the conversion target element to be subjected to image conversion. In S1006, the operation section 302 verifies whether the setting values include any error. Specifically, the operation section 302 determines that there is a setting value error in a case where the instruction to translate text has not been specified and the instruction to convert images has not been specified. The operation section 302 also determines that there is a setting value error in a case where the source or target language for translation is “unselected”. The operation section 302 also determines that there is a setting value error in a case where the instruction to convert only the conversion target elements has not been specified but no object has been specified as the conversion target element.

In S1008 in FIG. 10, the display control section 301 displays the details of the setting value error in the translation setting field. In a case where the instruction to convert only the conversion target elements has been specified but no object has been specified as the conversion target element, for example, the display control section 301 displays a dialogue box including an error message, such as “no target image for conversion has been selected”.

### <<Processing Flow of Service Server 102>>

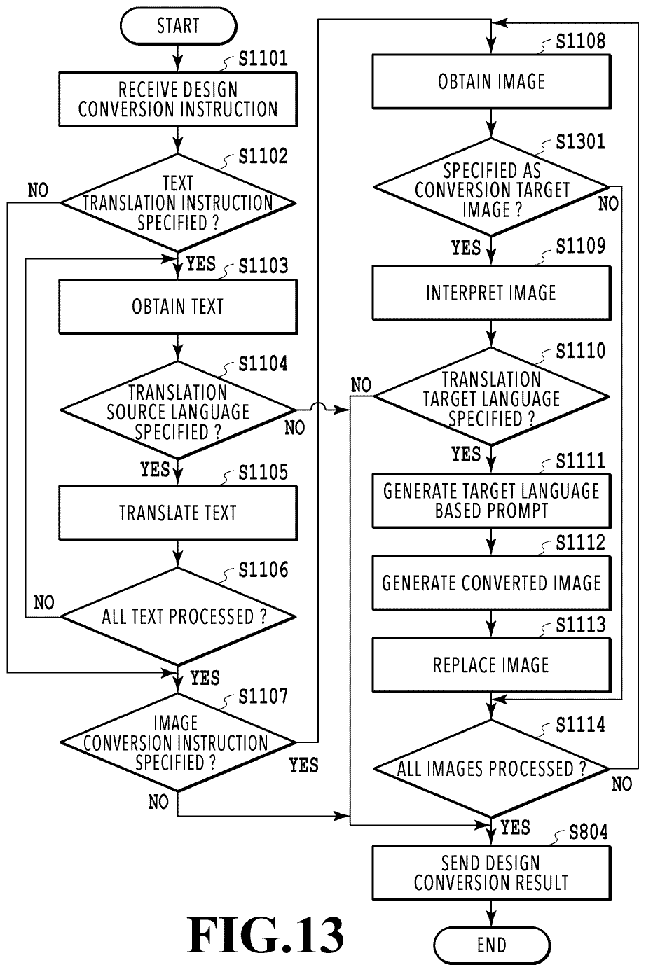

FIG. 13 is a flowchart illustrating processing executed by the service server 102 in the second embodiment. S803 in FIG. 8 corresponds to S1102, S1103, S1104, S1105, S1106, S1107, S1108, S1109, S1110, S1111, S1112, S1113, S1114, and S1301 of this flowchart. The processing in this flowchart is implemented by, for example, the CPU 221 loading a program stored in the ROM 222 into the RAM 223 and executing the same. The processing in this flowchart starts upon the data reception section 312 of the service server 102 receiving the design conversion instruction information from the application 300 of the operator PC 101. The following describes the differences between the processing in the flowchart in FIG. 13 and the processing in the flowchart of the first embodiment illustrated in FIG. 11.

The flowchart illustrated in FIG. 13 includes the processing in S1301, in addition to the processing of the first embodiment. In S1301, the image conversion section 314 determines whether the obtained image object has been specified as the conversion target element in the design conversion instruction information. In a case where it is determined that the obtained image object has been specified as the conversion target element, the processing proceeds to S1109. In a case where it is determined that the obtained image object is not specified as the conversion target element, the processing proceeds to S1114.

In the example in FIGS. 12A and 12B, conversion is performed for the image object 1211 in FIG. 12A. The image object 1211 is converted into an image object 1221 illustrated in FIG. 12B. On the other hand, conversion is not performed for an image object 1212 in FIG. 12A, which is not the conversion target element. The above example illustrates the case for non-text elements including images. However, the second embodiment is not limited thereto. As for text elements, in a case where the design data includes two or more text elements, only elements to be translated may be selected as translation target elements. Translation is executed for the selected translation target elements but not executed for non-translation target elements, not selected.

According to the second embodiment, only selected non-text elements, such as an image, in the design data are converted to non-text elements tailored to the cultural area of the text language. This enables appropriate conversion of the design data, improving the operator's convenience.

### Third Embodiment

In the first embodiment, a non-text element, such as an image, in the design data is interpreted, and a target language-based prompt based on the interpretation result is generated. Then the non-text element, such as an image, in the design data is replaced with a non-text element converted based on the target language-based prompt. This allows the operator to easily change a non-text element, such as an image, in the design data to a non-text element tailored to the cultural area of the text language. However, in a case where a non-text element in the design data is replaced with a non-text element converted based on the target language-based prompt, an image that does not match the cultural area intended by the operator may be generated. Examples thereof include a case for targeting an English-speaking Asian region. In a third embodiment, therefore, a non-text element, such as an image, in the design data is interpreted, and a locale-based prompt based on the interpretation result is generated. In the example described below, a non-text element, such as an image, in the design data is replaced with a non-text element converted based on the locale-based prompt. The following describes only the differences from the first embodiment.

### <<Processing Sequence>>

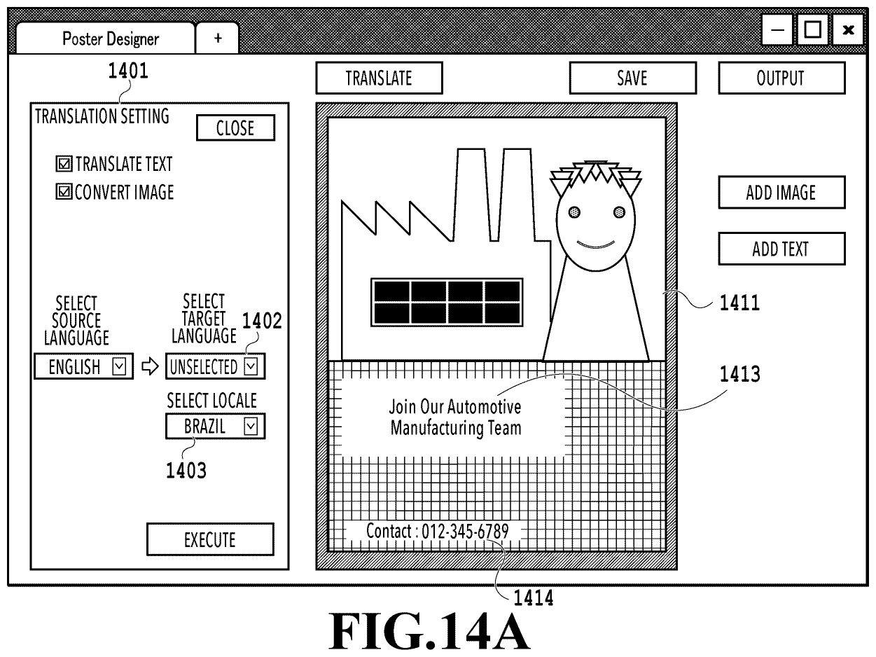

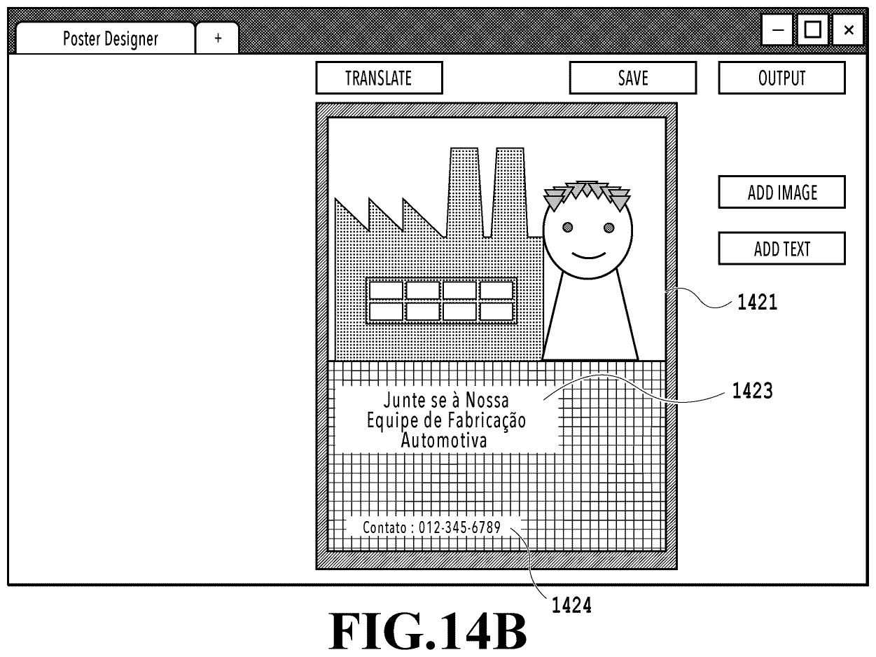

In S801 in FIG. 8, the operation section 302 of the application 300 receives the design conversion instruction from the user through the display and operation I/F 206. In the third embodiment, the design conversion instruction information includes a setting value that specifies the locale representing a country or region. FIGS. 14A and 14B illustrate an example of design conversion on the design data editing screen in the third embodiment. FIG. 14A illustrates a screen in which a translation setting field 1401 is displayed. The translation setting field 1401 includes a setting item 1403, which includes the locale representing a country or region as the translation target. As for the locale setting item 1403, the design data editing section 310 may store the past setting values in the conversion database 324 in advance and reflect the past setting values on the screen display of the setting item 1403. In the second embodiment, the setting item 1402 for the target language for translation may be set unselected as illustrated in FIG. 14A. FIG. 14A depicts the state where the instruction to translate text has been specified, the instruction to convert images has been specified, the source language for translation is “English”, the target language for translation is “unselected”, and the locale is “Brazil”.

### <<Processing Flow of Operator PC 101>>

In S1005 in FIG. 10, the operation section 302 obtains the setting values in the design conversion instruction. The setting values include the specification of the locale representing a country or region. In S1006, the operation section 302 verifies whether the setting values include any error. Specifically, the operation section 302 determines that there is a setting value error in a case where the instruction to translate text has not been specified and the instruction to convert images has not been specified. The operation section 302 also determines that there is a setting value error in a case where the source language for translation is “unselected”. The operation section 302 also determines that there is a setting value error in a case where the target language for translation is “unselected” and the locale is “unselected”.

In S1008 in FIG. 10, the display control section 301 displays the details of the setting value error in the translation setting field. In a case where the target language for translation is “unselected” and the locale is “unselected”, for example, the display control section 301 displays a dialogue box including an error message, such as “select a target language or locale”.

### <<Processing Flow of Service Server 102>>

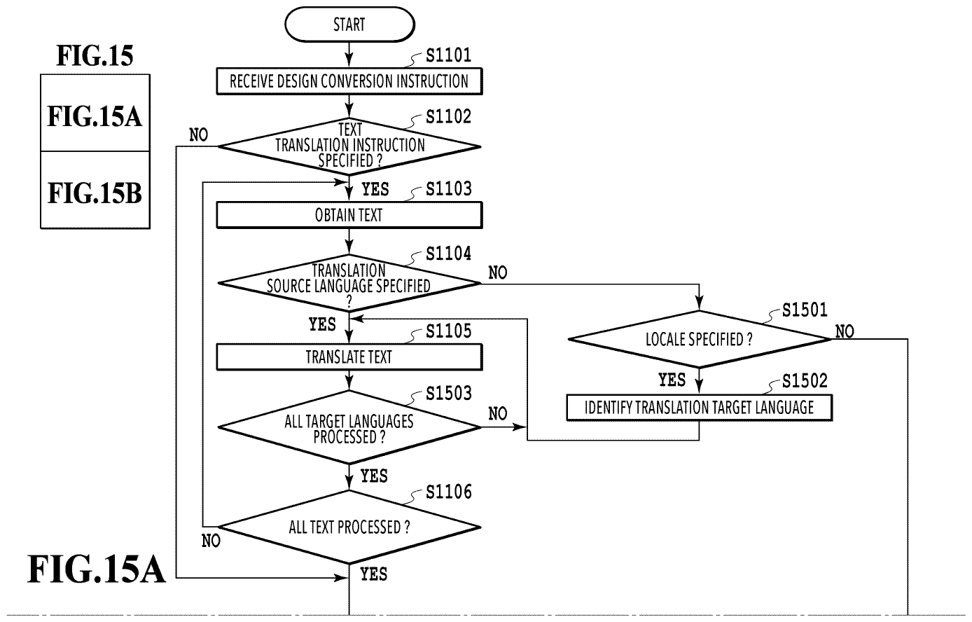

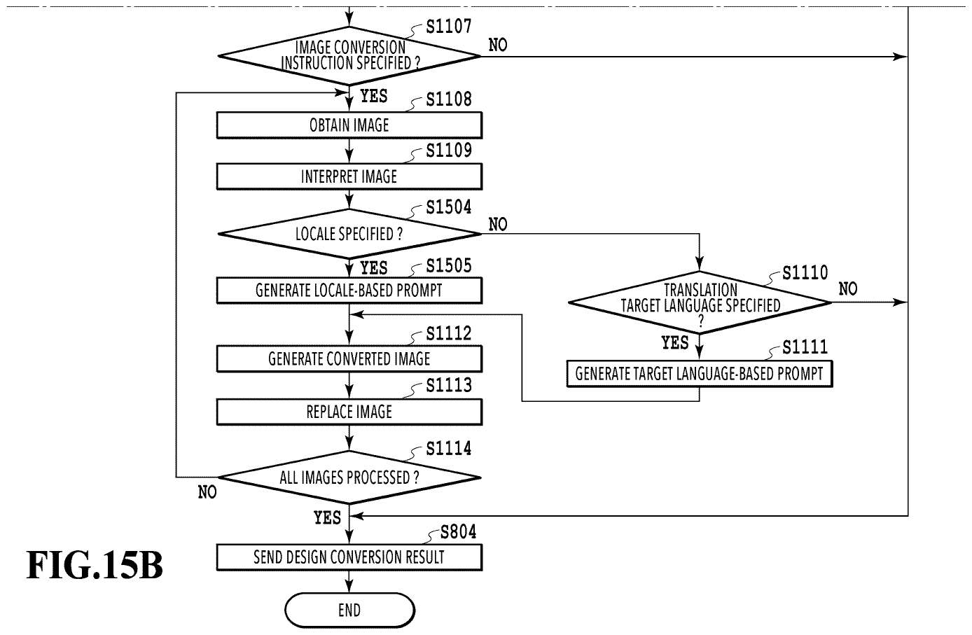

FIGS. 15A and 15B are flowcharts illustrating processing executed by the service server 102 in the third embodiment. S803 in FIG. 8 includes S1102, S1103, S1104, S1105, S1106, S1107, S1108, S1109, S1110, S1111, S1112, S1113, and S1114 of this flowchart. S803 in FIG. 8 further includes S1501, S1502, S1503, S1504, and S1505 of this flowchart. The processing in this flowchart is implemented by, for example, the CPU 221 loading a program stored in the ROM 222 into the RAM 223 and executing the same. The processing in this flowchart starts upon the data reception section 312 of the service server 102 receiving the design conversion instruction information from the application 300 of the operator PC 101. The following describes the differences between the processing in the flowcharts in FIGS. 15A and 15B and the processing in the flowchart of the first embodiment illustrated in FIG. 11.

In FIGS. 15A and 15B, the processing in S1501, S1502, S1503, S1504, and S1505 is added to the processing of the first embodiment illustrated in FIG. 11. In S1501, the text translation section 313 determines whether the locale has been specified in the design conversion instruction information. In a case where it is determined that the locale has been specified, the processing proceeds to S1502. In a case where it is determined that the locale has not been specified, the processing proceeds to S804.

In S1502, the text translation section 313 identifies the target language For translation based on the locale setting value. Specifically, pairs of locales and target languages corresponding thereto are registered in advance in the conversion database 324, for example, like “locale: Brazil, target language: Portuguese”. The text translation section 313 searches the conversion database 324 for the locale setting value to identify the target language for translation corresponding to this locale setting value. One locale may correspond to plural target languages. In a case where one locale corresponds to plural target languages, the same number of design conversion results as that of the target language for translations are generated. The method to identify the target language for translation is not limited to the above method. For example, the target language for translation may be identified by inputting the locale setting value to the multimodal large-scale language model 322 and causing the multimodal large-scale language model 322 to output the language used in the locale. In S1503, the text translation section 313 determines whether all the target language for translations have been processed. In a case where it is determined that all the target language for translations have been processed, the processing proceeds to S1106. In a case where it is determined that some of the target language for translation are unprocessed, the processing returns to S1105.

In S1504, the image conversion section 314 determines whether the locale has been specified in the design conversion instruction information. In a case where it is determined that the locale has been specified, the processing proceeds to S1505. In a case where it is determined that the locale has not been specified, the processing proceeds to S1110. In S1505, the image conversion section 314 generates the locale-based prompt using the locale setting value and the image interpretation result. Specifically, the image conversion section 314 generates a prompt to retain the content of the image of the obtained image object and generate a new image that matches the cultural area of the locale. In a case where the image interpretation result includes a text element, the text translation section 313 translates the text element into the target language for translation. The image conversion section 314 then generates the local-based prompt. In a case where the image conversion section 314 obtains an image object 1411 in FIG. 14 and the locale setting value is “Brazil”, for example, the image conversion section 314 generates the following prompt.

“A mechanic stands in front of a factory with his work clothes. Create an image that matches the Brazilian cultural area.”

In S1112, the image conversion section 314 generates a converted image using the target language-based prompt generated in the S1111 or the locale-based prompt generated in S1505. In the example in FIGS. 14A and 14B, the image of the image object 1411 in FIG. 14A is converted into a converted image represented by an image object 1421 in FIG. 14B. In this process, the converted image in FIG. 14B matches the Brazilian cultural area. Furthermore, text objects 1413 and 1414 in FIG. 14A are translated into Portuguese as illustrated in text objects 1423 and 1424 in FIG. 14B, respectively.

According to the third embodiment, a non-text element, such as an image, in the design data is interpreted, and the locale-based prompt based on the interpretation result is generated. The non-text element, such as an image, in the design data is replaced with a non-text element converted based on the locale-based prompt. This allows the operator to easily change a non-text element, such as an image, in the design data into a non-text element tailored to the cultural area of the locale, thus improving the operator's convenience.

### Fourth Embodiment

In the third embodiment, a non-text element, such as an image, in the design data is interpreted, and the locale-based prompt based on the interpretation result is generated. The non-text element, such as an image, in the design data is replaced with a non-text element converted based on the locale-based prompt. This allows the operator to easily change a non-text element, such as an image, in the design data into a non-text element tailored to the cultural area of the locale intended by the operator. However, in a case where the locale-based prompt does not explicitly describe elements that are not desired in the design in the cultural area of the intended locale, the converted non-text elements may include such undesired elements. Examples thereof include cases where the operator does not want the design to include inappropriate elements such as tobacco, alcohol, or pork in the cultural area of the intended locale. Therefore, in the fourth embodiment, a negative prompt is generated based on the locale. In the example described below, a non-text element, such as an image, in the design data, is replaced with a non-text element converted based on the locale-based prompt and a negative prompt. The following describes only the differences from the third embodiment.

### <<Processing Flow of Service Server 102>>

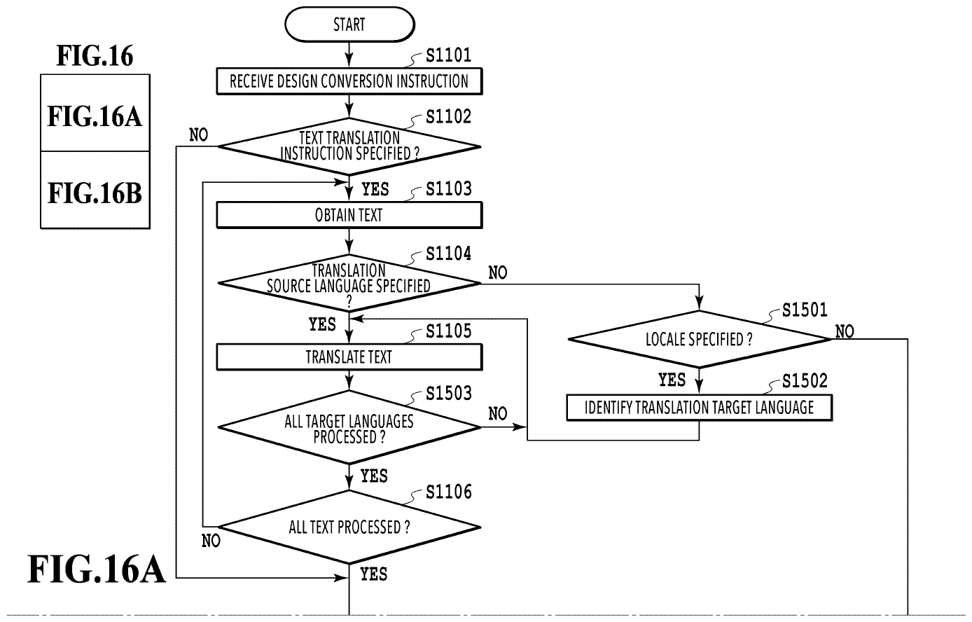

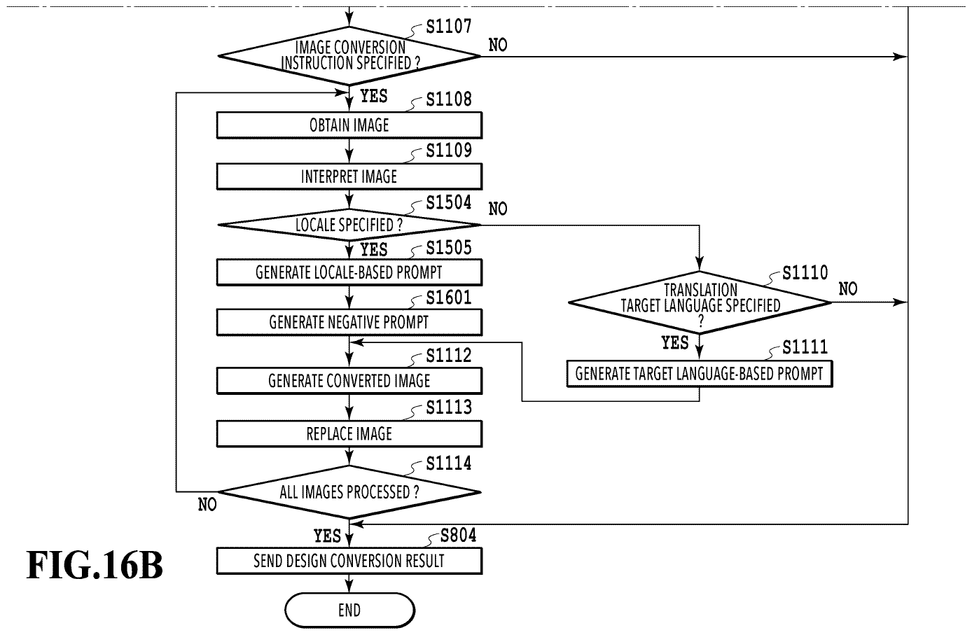

FIGS. 16A and 16B are flowcharts illustrating processing executed by the service server 102 in the fourth embodiment. S803 in FIG. 8 includes S1102, S1103, S1104, S1105, S1106, S1107, S1108, S1109, S1110, S1111, S1112, 81113, and S1114 of this flowchart. S803 in FIG. 8 further includes S1501, S1502, S1503, S1504, S1505, and S1601 of this flowchart. The processing in this flowchart is implemented by, for example, the CPU 221 loading a program stored in the ROM 222 into the RAM 223 and executing the same. The processing in this flowchart starts upon the data reception section 312 of the service server 102 receiving the design conversion instruction information from the application 300 of the operator PC 101. The following describes the differences between the processing in the flowcharts in FIGS. 16A and 16B and the processing in the flowcharts of the third embodiment illustrated in FIGS. 15A and 15B.

The flowcharts illustrated in FIGS. 16A and 16B include the processing in S1601 in addition to the processing in the flowchart of the third embodiment. In S1601, the image conversion section 314 generates a negative prompt using the locale setting value. Specifically, pairs of locales and negative prompt words corresponding thereto are registered in advance in the conversion database 324, for example, like “locale: Brazil, negative prompt word; tobacco”. The image conversion section 314 searches the conversion database 324 for the locale setting value to identify the negative prompt word corresponding thereto. The image conversion section 314 then generates a negative prompt. In a case where the locale setting value is “Brazil”, for example, the image conversion section 314 generates the following negative prompt.

“tobacco”

One locale may correspond to plural negative prompt words. The method to generate a negative prompt is not limited to the above method. For example, negative prompts may be generated by inputting the locale setting value to the multimodal large-scale language model 322 and causing the multimodal large-scale language model 322 to list and output words that should not be included in the design in the specified locale.

In S1112, the image conversion section 314 generates a non-text element converted using the target language-based prompt generated in S1111 or both the locale-based prompt generated in S1505 and the negative prompt generated in the S1601.

According to the fourth embodiment, a negative prompt is generated based on the locale. Then, a non-text element, such as an image, in the design data is replaced with a non-text element converted based on the locale-based prompt and the negative prompt. This allows the operator to easily change a non-text element, such as an image, in the design data to a converted non-text element that matches the cultural area of the intended locale and that does not include elements undesired in the cultural area of the locale, thus improving the operator's convenience.

### Fifth Embodiment

In the third embodiment, a non-text element, such as an image, in the design data is interpreted, and the locale-based prompt based on the interpretation result is generated. The non-text element, such as an image, in the design data is replaced with a non-text element converted based on the locale-based prompt. This allows the operator to easily change a non-text element, such as an image, in the design data into a non-text element tailored to the cultural area of the locale intended by the operator. However, it is necessary to receive the operator's input of the setting values of the target language for translation and the locale on the design editing screen, which reduces the operator's convenience. Therefore, the fifth embodiment describes an example in which the target language for translation and the locale are determined by obtaining setting information of the language and the locale set in the operator PC 101. The following describes only the differences from the third embodiment.

### <<Processing Flow of Service Server 102>>

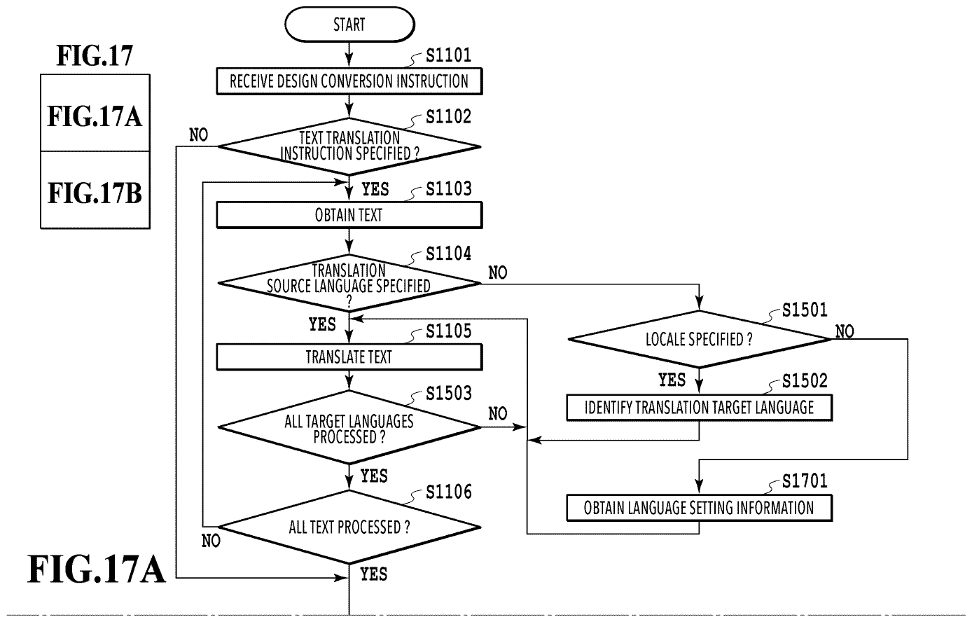

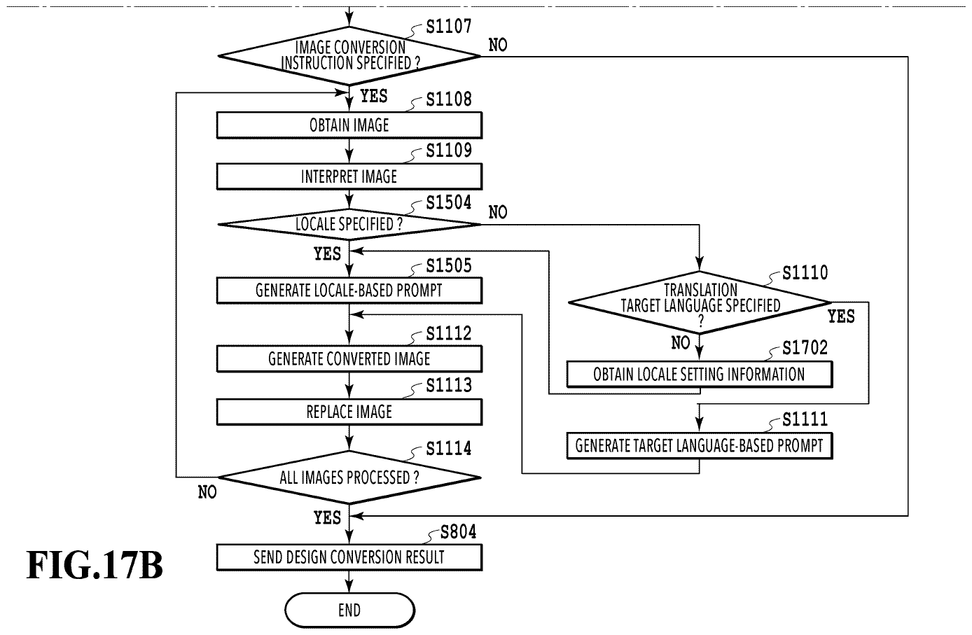

FIGS. 17A and 17B are flowcharts illustrating processing executed by the service server 102 in the fourth embodiment. S803 in FIG. 8 includes S1102, S1103, S1104, S1105, S1106, S1107, S1108, S1109, S1110, S1111, S1112, S1113, and S1114 of this flowchart. S803 in FIG. 8 further includes S1501, S1502, S1503, S1504, S1505, S1701, and S1702 of this flowchart. The processing in this flowchart is implemented by, for example, the CPU 221 loading a program stored in the ROM 222 into the RAM 223 and executing the same. The processing in this flowchart starts upon the data reception section 312 of the service server 102 receiving the design conversion instruction information from the application 300 of the operator PC 101. The following describes the differences between the processing in the flowcharts in FIGS. 17A and 17B and the processing in the flowcharts of the third embodiment illustrated in FIGS. 15A and 15B.

The flowcharts illustrated in FIGS. 17A and 17B include the processing in S1701 and S1702 in addition to the processing in the flowchart of the third embodiment. In S1701, the text translation section 313 obtains language setting information of the operator PC 101. In this process, the processing sequence of the service server 102 and the operator PC 101 is as follows. First, the data translation section 311 of the service server 102 transmits to the application 300 of the operator PC 101, an instruction to transmit language and locale setting information. The data reception section 304 of the application 300 of the operator PC 101 receives the instruction to transmit the language and locale setting information from the service server 102. The data transmission section 303 of the application 300 of the operator PC 101 transmits the language and locale setting information set in the operator PC 101 to the service server 102. The data reception section 312 of the service server 102 receives the language and locale setting information from the application 300 of the operator PC 101. In a case where the design conversion instruction information includes the language and locale setting information, the following setting process may be performed without executing the aforementioned processing sequence. That is, the language and locale setting information set in the operator PC 102 may be set in the language and locale setting information in the design conversion instruction information.

The language and locale setting information is expressed in the form of “language_ locale”. The text translation section 313 of the service server 102 obtains the language setting information from the language and locale setting information received by the data reception section 312. For example, in a case where the language and locale setting information of the operator PC 101 is “en_IN”, the obtained language setting information is “English”.

In S1702, the image conversion section 314 obtains the locale setting information of the operator PC 101. In this process, the service server 102 receives the language and locale setting information from the application 300 of the operator PC 101 through the same processing sequence as in S1701. Alternatively, in a case where the language and locale setting information set in the operator PC 101 are set in the design conversion instruction information, the set language and locale setting information may be used. The image conversion section 314 of the service server 102 obtains the locale setting information from the received language and locale setting information. In a case where the language and locale setting information of the operator PC 101 is “en_IN”, for example, the obtained locale setting information is “India”.

According to the fifth embodiment, the target language for translation and the locale are determined by obtaining the setting information of the language and the locale of the operator PC. This eliminates the need to receive the operator's input of the setting values of the target language for translation and the locale on the design editing screen, thus improving the operator's convenience.

### Sixth Embodiment

In the third embodiment, a non-text element, such as an image, in the design data is interpreted, and the locale-based prompt based on the interpretation result is generated. The non-text element, such as an image, in the design data is replaced with a non-text element converted based on the locale-based prompt. This allows the operator to easily change a non-text element, such as an image, in the design data into a non-text element tailored to the cultural area of the locale intended by the operator. However, it is necessary to receive the operator's input of the setting values of the target language for translation and the locale on the design editing screen, which reduces the operator's convenience. Therefore, the sixth embodiment describes an example in which the target language for translation and the locale are determined based on the position information of the operator PC 101. The following describes only the differences from the third embodiment.

### <<Processing Flow of Operator PC 101>>

In S1006 in FIG. 10, the operation section 302 verifies whether the setting values include any error. Specifically, the operation section 302 determines that there is a setting value error in a case where the instruction to translate text has not been specified and the instruction to convert images has not been specified. The operation section 302 also determines that there is a setting value error in a case where the source language for translation is “unselected”. In a case where the target language for translation is “unselected” or the locale is “unselected”, the operation section 302 determines that there is no setting value error.

### <<Processing Flow of Service Server 102>>

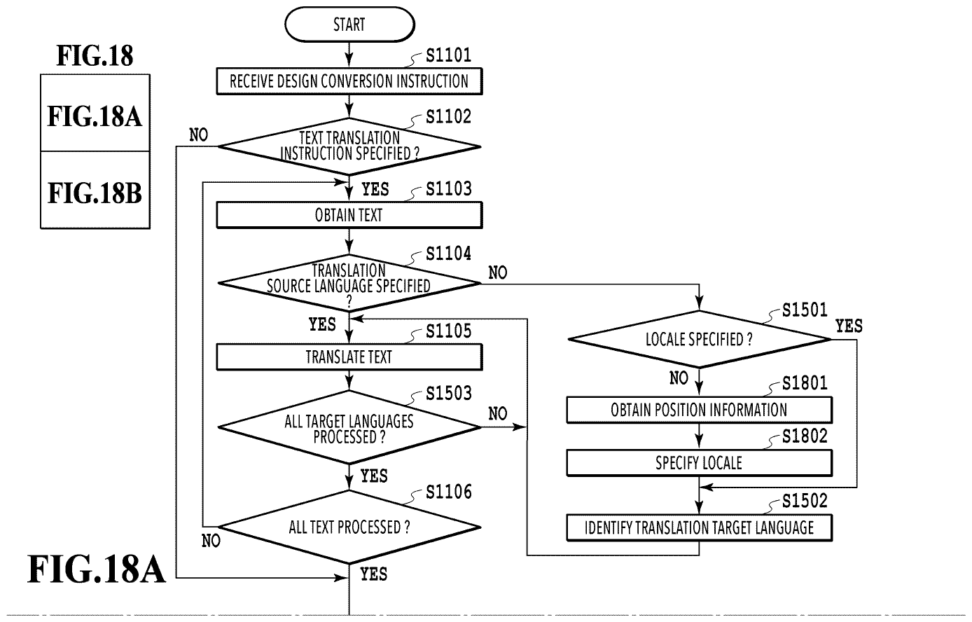

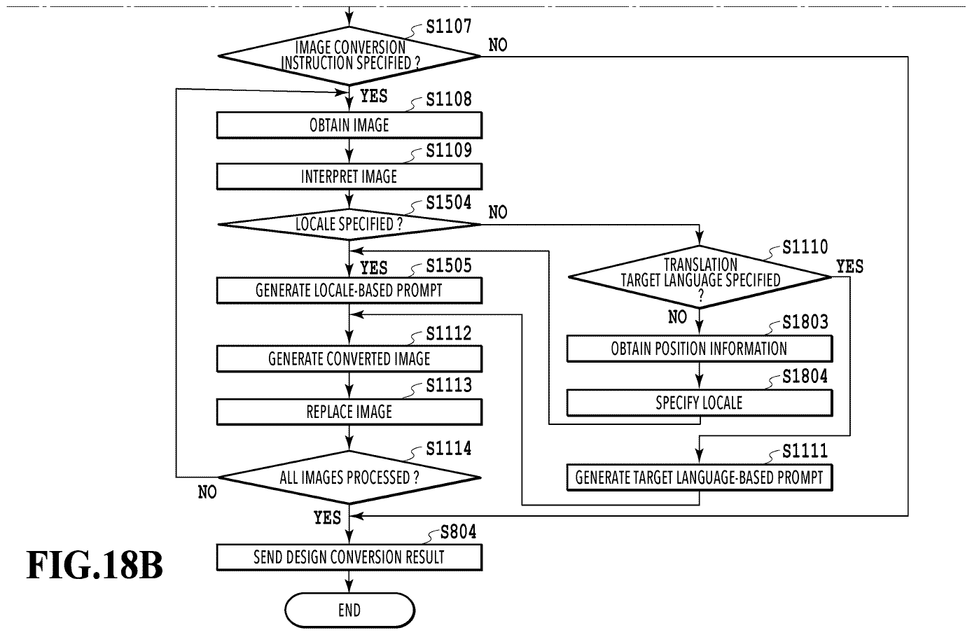

FIGS. 18A and 18B are flowcharts illustrating processing executed by the service server 102 in the sixth embodiment, S803 in FIG. 8 includes S1102, S1103, S1104, S1105, S1106, S1107, S1108, S1109, S1110, S1111, S1112, S1113, and S1114 of this flowchart. S803 in FIG. 8 further includes S1501, S1502, S1503, S1504, S1505, S1801, S1802, S1803, and S1804 of this flowchart. The processing in this flowchart is implemented by, for example, the CPU 221 loading a program stored in the ROM 222 into the RAM 223 and executing the same. The processing in this flowchart starts upon the data reception section 312 of the service server 102 receiving the design conversion instruction information from the application 300 of the operator PC 101. The following describes the differences between the processing in the flowcharts in FIGS. 18A and 18B and the processing in the flowcharts of the third embodiment illustrated in FIGS. 15A and 15B.

The flowcharts illustrated in FIGS. 18A and 18B include the processing in S1801, S1802, S1803, and S1804 in addition to the processing in the flowchart of the third embodiment. In S1801, the text translation section 313 obtains the position information of the operator PC 101. In this process, the processing sequence of the service server 102 and the operator PC 101 is as follows. First, the data transmission section 311 of the service server 102 transmits to the application 300 of the operator PC 101, an instruction to transmit the position information. The data reception section 304 of the application 300 of the operator PC 101 receives the instruction to transmit the position information from the service server 102. The data transmission section 303 of the application 300 of the operator PC 101 transmits the position information of the operator PC 101 to the service server 102. The data reception section 312 of the service server 102 receives the position information from the application 300 of the operator PC 101. The position information is represented in the form of “latitude, longitude”. The text translation section 313 of the service server 102 obtains the position information received by the data reception section 312. The processing sequence above is described for the case where the design conversion instruction information does not include the position information of the operator PC 101. In a case where the design conversion instruction information includes the position information of the operator PC 101, the position information of the operator PC 101 may be obtained from the design conversion instruction information without executing the aforementioned processing sequence.

In S1802, the text translation section 313 identifies the locale based on the obtained position information. Specifically, pairs of locales and ranges of position information are registered in advance in the conversion database 324. The image conversion section 314 searches the conversion database 324 for the position information to identify the locale corresponding thereto. In a case where the position information is “15°E, 50°N”, for example, the locale is identified as “Germany”.

In S1803, the image conversion section 314 obtains the position information of the operator PC 101. In this process, the service server 102 receives the position information from the application 300 of the operator PC 101 through the same processing sequence as that in S1801. The image conversion section 314 of the service server 102 obtains the received position information. In S1804, the image conversion section 314 identifies the locale based on the obtained position information. The identification method is the same as that in S1802.

According to the sixth embodiment, the target language for translation and the locale are determined based on the position information of the operator PC. This eliminates the need to receive the operator's input of the setting values of the target language for translation and the locale on the design editing screen, thus improving the operator's convenience.

According to the technology of the present disclosure, the design data can be appropriately converted.

### Other Embodiments

The present disclosure can also be implemented through processing including supplying a program for implementing one or more functions of the embodiments described above to a system or an apparatus by using a network or a storage medium, and reading and executing, by a computer of the system or the apparatus, the program. The computer includes one or a plurality of processors or circuits, and may include a network of a plurality of individual computers or a plurality of individual processors or circuits, to read and execute a computer-readable instruction.

The processor or circuit may include a central processing unit (CPU), a micro processing unit (MPU), a graphics processing unit (GPU), an application specific integrated circuit (ASIC), or a field-programmable gate array (FPGA). Moreover, the processor or circuit can include a digital signal processor (DSP), a data flow processor (DFP), or a neural processing unit (NPU).

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-129940, filed Aug. 6, 2024, which is hereby incorporated by reference herein in its entirety.

What is claimed is:

1. A non-transitory computer-readable storage medium storing a program for causing a computer to function as:
a display control unit configured to display design data; and
a reception unit configured to receive an input of setting information used in conversion of data included in the design data, wherein
the display control unit executes display control to display design data in which text data included in the design data has been translated based on the setting information and image data included in the design data has been converted into image data generated based on the setting information.

2. The storage medium according to claim 1, wherein the image data generated based on the setting information is generated based on the image data included in the design data and the setting information.

3. The storage medium according to claim 1, wherein the image data generated based on the setting information is similar to the image data included in the design data.

4. The storage medium according to claim 1, wherein the text data is editable.

5. The storage medium according to claim 1, wherein the image data included in the design data is a shape.

6. The storage medium according to claim 1, wherein the image data included in the design data is different from the text data and includes a character.

7. The storage medium according to claim 1, wherein the image data included in the design data is different from the text data and does not include any character.

8. The storage medium according to claim 6, wherein the image data generated based on the setting information is image data in which characters included in the image data are translated.

9. The storage medium according to claim I, wherein the reception unit receives a selection of the setting information.

10. The storage medium according to claim 1, wherein the setting information is information indicating a language.

11. The storage medium according to claim 1, wherein the setting information is information indicating a region.

12. The storage medium according to claim 1, wherein the receiving unit receives an input of an execution instruction to execute conversion of the design data, and upon the input of the execution instruction, the display control unit executes the display control.

13. The storage medium according to claim 1, wherein, in a case where the design data includes a plurality of image data, the image data selected from the plurality of the image data is converted into image data generated based on the setting information.

14. The storage medium according to claim 1, wherein the image data generated based on the setting information is generated based on a negative prompt.

15. The storage medium according to claim 1, wherein the setting information includes information indicating an impression of the image data included in the design data, and the image data is converted into image data generated based on the impression and the setting information.

16. The storage medium according to claim 1, wherein
the program is executed by a second information processing apparatus that is capable of communicating with a first information processing apparatus and causes the computer to further function as:
a transmitting unit configured to transmit the setting information to the first information processing apparatus; and
a reception unit configured to receive design data generated by the first information processing apparatus by translating the text data based on the setting information and converting the image data into image data generated based on the setting information.

17. The storage medium according to claim 1, wherein, in a case where the reception unit receives an input of information indicating a region, the text data is translated based on a language corresponding to the information indicating the region, and the image data is converted into image data generated based on the information indicating the region.

18. An information processing apparatus, comprising:
one or more processors and/or circuitry which function as:
a display control unit configured to display design data; and
a reception unit configured to receive an input of setting information used in conversion of data included in the design data, wherein
the display control unit executes display control to display design data in which text data included in the design data has been translated based on the setting information and image data included in the design data has been converted into image data generated based on the setting information.

19. A method of controlling an information processing apparatus, comprising:
performing display control to display design data; and
receiving an input of setting information used in conversion of data included in the design data, wherein
the performing display control includes executing display control to display design data in which text data included in the design data has been translated based on the setting information and image data included in the design data has been converted into image data generated based on the setting information.

20. An information processing system in which a first information processing apparatus and a second information apparatus communicate each other, the first information processing apparatus, comprising:
one or more processors and/or circuitry which function as:
a conversion control unit configured to translate text data included in design data based on setting information used in conversion of the design data managed by the first information processing apparatus and convert image data included in the design data into image data generated based on the setting information; and
a transmitting unit configured to transmit converted design data into which the design data is converted based on the control of the conversion control unit to the second information processing apparatus,
the second information processing apparatus, comprising:
one or more processors and/or circuitry which function as:
a reception unit configured to receive the converted design data from the first information processing apparatus; and
a display control unit configured to display the converted design data.
